(19) United States
(12) Patent Application Publication
(10) Pub. No.: US 2006/0045355 A1
(43) Pub. Date: Mar. 2, 2006

(54) Mobile terminal, and computer controlling method and program for use in the same

(75) Inventors: Fumiyuki Ito, Kanagawa (JP); Hiroki Matsumoto, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/204,959

(22) Filed: Aug. 16, 2005

(30) Foreign Application Priority Data
Aug. 26, 2004 (JP) 246494/2004(PAT.)

(51) Int. Cl. G06K 9/62

(52) U.S. Cl. 382/224

(57) ABSTRACT

In a mobile terminal capable of making cost required for a server or the like other than a terminal unnecessary and of simplifying key operations, when a user inputs an instruction to copy a desired page by operating an operation portion (12), a copy control portion (22) fetches in character string data of the page concerned and data discrimination means (24) classifies the fetched character string data into the character data of predetermined character string types to store the classified character string data in a storage area of a storage portion (14). When the user inputs an instruction to paste the character string data to an input column existing in a desired page by operating the operation portion (12), the copy control portion (22) checks the character string type corresponding to the input column of the designated page, and acquires the character string data of the character string type corresponding to the input column from the storage area of the storage portion (14) to paste the acquired character string data.

### BACKGROUND OF THE INVENTION

The present invention relates to improvements in a mobile terminal having a function of copying character data, a method of controlling a computer, and a program.

Heretofore, a copy/paste function of fetching in desired character data to paste and/or substitute the desired character data thus fetched to and/or into a desired input position has been used in a mobile terminal, a computer terminal, and the like. Since predetermined key operations need to be performed in order to use such a copy/paste function, it is desired to simplify the key operations.

For example, JP 2002-290543 A discloses a technique in which a full data copy key, and a character string copy key are set, and thus the designation of full data displayed on a screen as a copy range and the designation of registered specific character string data as a copy range can be simplified. In addition, JP 2002-94685 A discloses a data pasting method in which in order to read the contents in which inputted data is reflected, the data inputted from a cellular phone or the like is received and stored in a memory, and the data to be used in the contents is retrieved from the memory and pasted and/or substituted to and/or for the contents in order to be transmitted to the cellular phone or the like.

However, the above-mentioned prior art involves such a problem that the key operations are not necessarily sufficiently simplified.

For example, the technique disclosed in JP 2002-290543 A involves such a problem that when there are a plurality of paste destinations for the character string data copied to be fetched in a clip board, the copy/paste operation needs to be repeatedly performed plural times, and thus the number of times of the key operations increases.

In addition, the technique disclosed in JP 2002-94685 A involves such a problem that it is necessary to specially provide a server including a memory and serving to perform an operation for transmitting/receiving data to/from a terminal in addition to the terminal such as the cellular phone.

### SUMMARY OF THE INVENTION

The present invention has been made in the light of the above-mentioned problems associated with the prior art, and it is, therefore, an object of the present invention to provide a mobile terminal, a method of controlling a computer, and a program which are capable of making cost required a server or the like other than a terminal unnecessary and of simplifying key operations.

In order to attain the above-mentioned object, according to an aspect of the present invention, there is provided a mobile terminal having a function of copying character data, the mobile terminal including: a copy device which copies and fetches therein arbitrary character string data; a discrimination device which classifies the fetched character string data into the character data of predetermined character string types to punctuate the character string data; and a character string data storage device which stores therein the classified character string data together with classification item names thereof.

Preferably, the mobile terminal further includes first paste device which selects the character string data of the character string type corresponding to a paste destination from among the character string data stored in the character string data storage device to paste the selected character string data. In addition, preferably, the first paste device selects the character string data of the character string type corresponding to a plurality of paste destinations to paste the selected character string data.

In addition, preferably, the mobile terminal further includes second paste device which selects the character string data from among the character string data stored in the character string data storage device in accordance with an instruction from a user to paste the selected character string data. Also, preferably, the second paste device receives an instruction to select a plurality of character string data.

In addition, according to another aspect of the present invention, there is provided a method of controlling a computer, the method including the steps of: copying and fetching in arbitrary character string data; classifying the fetched character string data into the character data of predetermined character string types to punctuate the character string data; and storing the classified character string data together with classification item names thereof.

Preferably, the method of controlling a computer further includes the step of selecting the character string data of the character string type corresponding to a paste destination from among the stored character string data to paste the selected character string data.

In addition, preferably, the method of controlling a computer further includes the step of selecting the character string data from among the stored character string data in accordance with an instruction from a user to paste the character string data selected.

Moreover, according to still another aspect of the present invention, there is provided a mobile terminal having a function of copying character data, the mobile terminal including: means for copying and fetching in arbitrary character string data; means for classifying the fetched character string data into the character data of predetermined character string types to punctuate the character string data; and means for storing classified the character string data together with classification item names thereof.

In addition, the mobile terminal further includes means for selecting the character string data of the character string type corresponding to a paste destination from among the stored character string data.

Also, the mobile terminal further includes means for selecting the character string data from among the stored character string data in accordance with an instruction from a user to paste the selected character string data.

According to those aspects of the present invention described above, since the fetched character string data is classified into the character data of the predetermined character string types to be stored, the character string data of the character string type corresponding to the paste destination can be selected to be pasted. Consequently, it is possible to simplify the key operations during a copy/paste mode.

### BRIEF DESCRIPTION OF THE DRAWINGS

FIG. 1 is a block diagram showing a configuration of a mobile terminal according to an embodiment of the present invention;

FIG. 2 is a diagram showing an example of a storage area secured in a storage portion in the mobile terminal according to the embodiment shown in FIG. 1;

FIG. 3 is a flow chart explaining an example of a copy operation performed by the mobile terminal according to the embodiment shown in FIG. 1;

FIG. 4 is a flow chart explaining contents of a data classification process in the flow chart shown in FIG. 3;

FIG. 5 is a flow chart explaining an example of a paste operation performed by the mobile terminal according to the embodiment shown in FIG. 1;

FIG. 6 is a flow chart explaining another example of a paste operation performed by the mobile terminal according to the embodiment shown in FIG. 1;

FIG. 7a is a diagram showing an example of a screen during the paste operation performed by the mobile terminal according to the embodiment shown in FIG. 1;

FIG. 7b is a diagram showing an example of a screen during the paste operation performed by the mobile terminal according to the embodiment shown in FIG. 1;

FIG. 8a is a diagram showing another example of a screen during the paste operation performed by the mobile terminal according to the embodiment shown in FIG. 1; and

FIG. 8b is a diagram showing another example of a screen during the paste operation performed by the mobile terminal according to the embodiment shown in FIG. 1.

### DESCRIPTION OF THE PREFERRED EMBODIMENT(S)

Hereinafter, the preferred embodiments of the present invention will be described in detail with reference to the accompanying drawings.

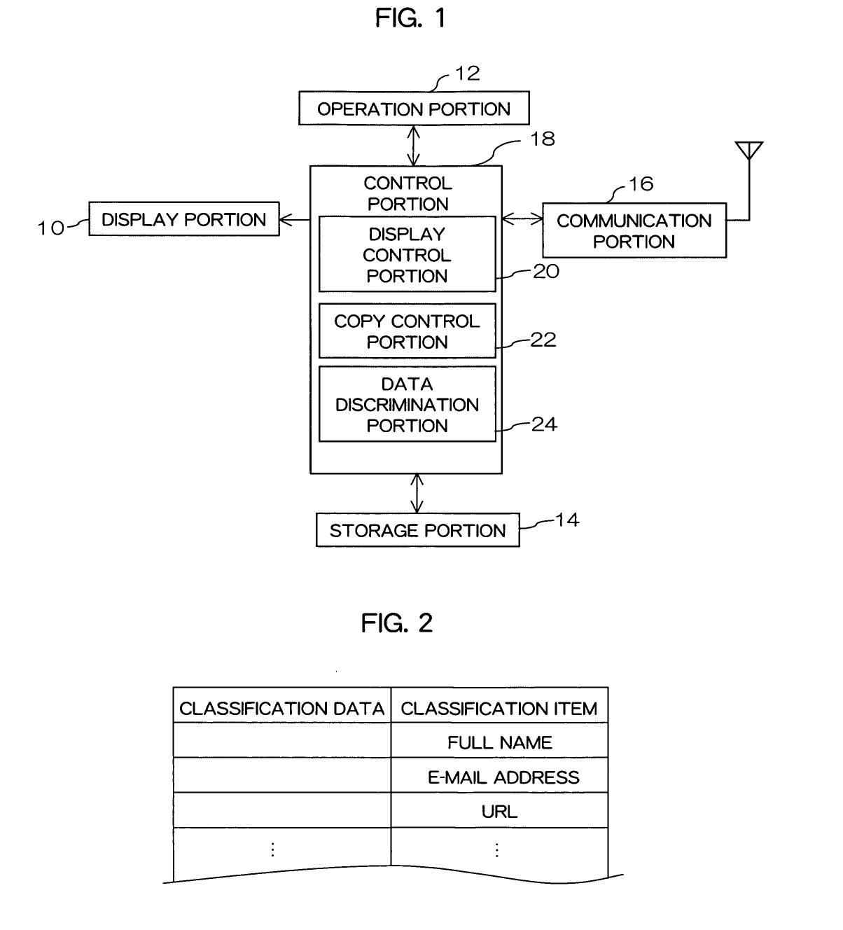

FIG. 1 is a block diagram showing a configuration of a mobile terminal according to an embodiment of the present invention. Referring to FIG. 1, the mobile terminal includes a display portion 10, an operation portion 12, a storage portion 14, a communication portion 16, and a control portion 18.

The display portion 10, for example, is constituted by a liquid crystal display or the like, and serves to display thereon the contents of key input such as character data, various kinds of figures, or the like. Incidentally, when the present invention is applied to a personal computer or the like, the display portion 10 may also be constituted by a CRT or the like.

The input of the character data or the like through the keying operation is performed by operating the operation portion 12 shown in FIG. 1. The operation portion 12, for example, is constituted by operation buttons or the like of the mobile terminal. However, when the present invention is applied to a personal computer or the like, the operation portion 12 may also be constituted by a keyboard, area specification means such as a mouse, bar codes, or the like. With the operation portion 12, in addition to an operation for inputting the character data or the like, an operation for inputting an instruction to perform copy/paste or the like of the character data or the like is also carried out.

The storage portion 14, for example, is constituted by a RAM (Random Access Memory) for work of the control portion 18, an EEPROM as a nonvolatile memory, a magnetic storage medium, or the like. The various kinds of data such as the contents of the key input is stored in the storage portion 14.

The communication portion 16 communicates with a base station by utilizing the known method, thereby realizing a call function of a mobile communication terminal. It should be noted that when the present invention is applied to the personal computer or the like, the communication portion is not necessarily required.

The control portion 18, for example, is constituted by a CPU (Central Processing Unit) or the like. The control portion 18 controls the operations of the display portion 10, the operation portion 12, the storage portion, and the communication portion 16 while transmitting/receiving data to/from the display portion 10, the operation portion 12, the storage portion, and the communication portion 16.

A display control portion 20 of the control portion 18 mainly controls the contents displayed on the display portion 10. A copy control portion 22 controls a copy operation for setting a copy range, fetching in character string data existing in the copy range thus set and storing the character string data thus fetched in the storage portion 14, retrieving the character string data corresponding to a paste destination from the storage portion 14, and pasting and/or substituting the character string data to and/or into the paste destination. A data discrimination portion 24 performs the control for classification of the character string data into the character data of character string types which will be described later.

Incidentally, the above-mentioned control portion 18 may be a computer which is configured with a CPU as a main constituent element. In this case, the CPU executes a program stored in a memory card or any other suitable medium, thereby realizing the functions of the control portion 18.

FIG. 2 shows an example of a storage area secured in the storage portion 14. Referring to FIG. 2, the data discrimination portion 24 classifies the character string data fetched by the copy control portion 22 based on a copy instruction inputted through the operation portion 12 by a user, into the predetermined character string types to punctuate the character string data thereby obtaining classification data. The classification data is then stored in the storage area. In addition, the classification data is stored together with the respective classification items in the storage area. As regards those classification items, for example, there are “full name”, “E-mail address”, “URL”, and the like of a user, etc. However, the present invention is not intended to be limited thereto, and thus “telephone number” and the like can be set if necessary. Here, the storage portion 14 in which the storage area shown in FIG. 2 is set corresponds to character string data storage means of the present invention.

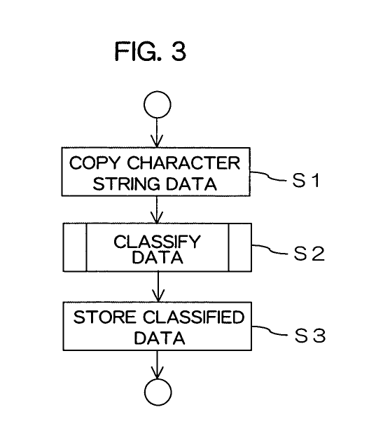

FIG. 3 shows a flow chart explaining an example of a copy operation performed by the mobile terminal according to the embodiment of the present invention. Referring to FIG. 3, when for example, the user inputs an instruction to copy all desired pages by operating the operation portion 12, the copy control portion 22 fetches in character string data of the pages concerned (S1).

Then, the data discrimination portion 24 classifies the character string data thus fetched into the character data of predetermined character string types to punctuate the character string data. As regards the character string types in this case, as stated with respect to the classification items described above, there are “full name”, “telephone number”, “E-mail address”, “URL”, and the like of the user, etc. “Full name”, for example, can be judged by reading source codes in the pages concerned. In addition, “telephone number” can be judged on the basis of a keyword such as “090” contained in the character string; “E-mail address” can be judged on the basis of a keyword such as “@” contained in the character string; and “URL” can be judged on the basis of a keyword such as “http:” contained in the character string. Consequently, the data discrimination portion 24 classifies the character string data into the data sets of character string types to punctuate the character string data, thereby performing the data classification (S2). Incidentally, the punctuation positions for the character string data are judged by referring to “punctuation marks”, points where kinds of characters such as “2 byte character” and “1 byte alphanumeric characters” change, “line feed”, and the like as well.

The copy control portion 22 stores the classified character string data together with the classification items thereof described above in the storage area of the storage portion 14 (S3).

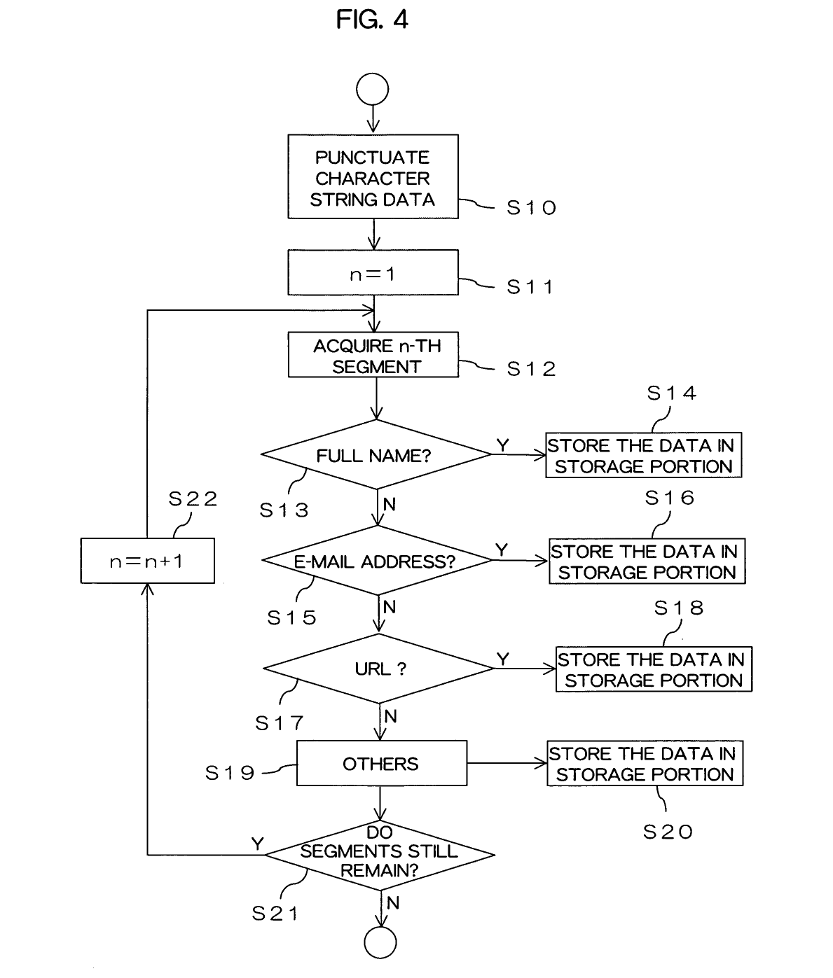

FIG. 4 shows a flow chart explaining an example of the data classification process in the flow chart shown in FIG. 3. Referring to FIG. 4, the data discrimination portion 24 classifies the character string data fetched by the copy control portion 22 into the character data of the predetermined character string types to punctuate the character string data (S10). The character string data is punctuated so as to obtain the date set of the predetermined character string type every punctuation by referring to the source codes of the pages concerned, the keywords, the punctuation marks, the points where the kinds of characters change, the line feed, and the like. A method of adding the data used to identify the character string data every predetermined segment to the character string data is considered as a method of performing the punctuation. However, the method of performing the punctuation is not especially limited. In addition, the data discrimination portion 24 gives a segment number every data set segmented through the above-mentioned punctuation.

Next, the data discrimination portion 24 sets 1 to an integral number (n=1) (S11), and acquires an n-th segment (i.e., a first segment) of the punctuated character string data (S12). The data discrimination portion 24 judges whether or not the character string type of the segment of the acquired character string data corresponds to “full name” (S13). When the data discrimination portion 24 judges in S13 that the character string type corresponds to “full name”, the copy control portion 22 stores the segment of the character string data concerned together with the classification item of “full name” in the storage area of the storage portion 14 shown in FIG. 2 (S14).

On the other hand, when judging in S13 that the character string type does not correspond to “full name”, the data discrimination portion 24 judges whether or not the character string type of the segment of the acquired character string data corresponds to “E-mail address” (S15). When the data discrimination portion 24 judges in S15 that the character string type corresponds to “E-mail address”, the copy control portion 22 stores the segment of the character string data concerned together with the classification item of “E-mail address” in the storage area of the storage portion 14 shown in FIG. 2 (S16).

On the other hand, when judging in S15 that the character string type does not correspond to “E-mail address”, the data discrimination portion 24 judges whether or not the character string type of the segment of the character string data corresponds to “URL” (S17). When the data discrimination portion 24 judges in S17 that the character string type of the segment of the character string data corresponds to “URL”, the copy control portion 22 stores the segment of the character string data concerned together with the classification item of “URL” in the storage area of the storage portion 14 shown in FIG. 2 (S18).

On the other hand, when the data discrimination portion 24 judges in S17 that the character string type of the segment of the character string data does not correspond to “URL”, the copy control portion 22 gives the classification item of “others” to the segment of the character string data (S19), and stores the segment of the character string data concerned together with the classification item of “others” in the storage area of the storage portion 14 (S20) Incidentally, while in the above-mentioned example, the three items: “full name”; “E-mail address”; and “URL” are given as the classification items, “telephone number” and other classification items may be added to or exchanged for any ones.

Next, the data discrimination portion 24 checks whether or not the segments of the character string data still remain (S21). When checking in S21 that segments of the character string data still remain, the data discrimination portion 24 sets (n+1) to n (n=2), and the operations are repeatedly performed from S12. On the other hand, when the data discrimination portion 24 checks in S21 that no segment of the character string data remains, the operation for classifying the data is completed.

The above-mentioned operation portion 12 and copy control portion 22 operate as copy means of the present invention. In addition, the data discrimination portion 24 corresponds to data discrimination means of the present invention.

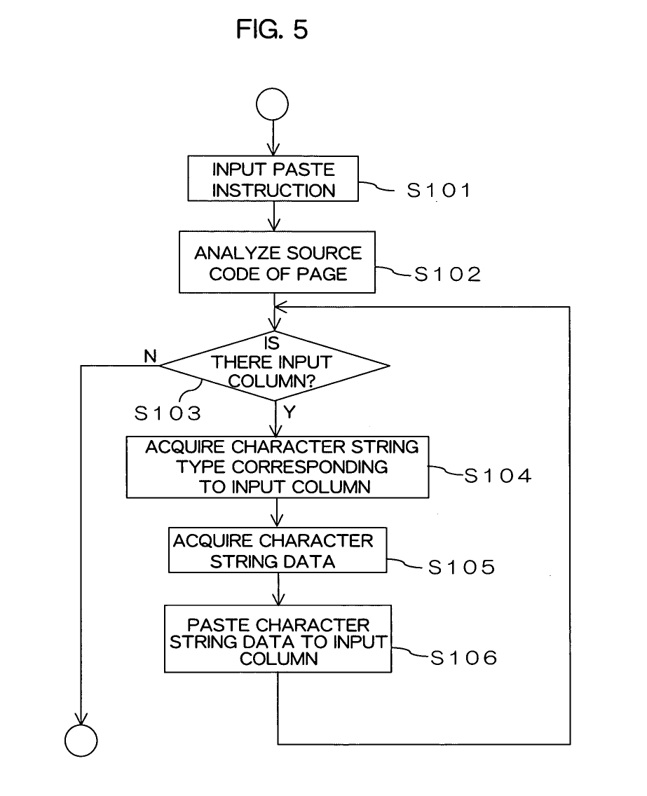

FIG. 5 shows a flow chart explaining an example of a paste operation performed by the mobile terminal according to the embodiment of the present invention. Referring to FIG. 5, when the user, for example, inputs an instruction to paste the character string data to an input column existing in a desired page by operating the operation portion 12 (S101), the copy control portion 22 analyzes the source code of the page for which the paste instruction is inputted (S102) to check whether or not there is the input column (S103).

When checking in S103 that there is the input column, the copy control portion 22 analyzes the source code of the above-mentioned page to acquire the character string type corresponding to the input column as a paste destination (S104).

Next, the copy control portion 22 acquires the character string data of the character string type corresponding to the above-mentioned input column from the storage area of the storage portion 14 shown in FIG. 2 (S105). The copy control portion 22 judges that character string type on the basis of the classification items stored in the storage area of the storage portion 14.

The copy control portion 22 sticks and pastes the acquired character string data to the above-mentioned input column (S106).

After completion of the operation for pasting the character string data, the operation is repeatedly performed from S103. On the other hand, when the copy control portion 22 judges in S103 that there is no input column, the paste operation is completed. The copy control portion 22 selects the character string data of the character string type corresponding to the paste destination from among the character string data stored in the storage portion 14 to paste the selected character string data in such a manner. Consequently, the number of times of the key operations during the copy/paste mode can be reduced and thus the key operations can be simplified.

Here, the operation portion 12 and the copy control portion 22 operate as first paste means of the present invention.

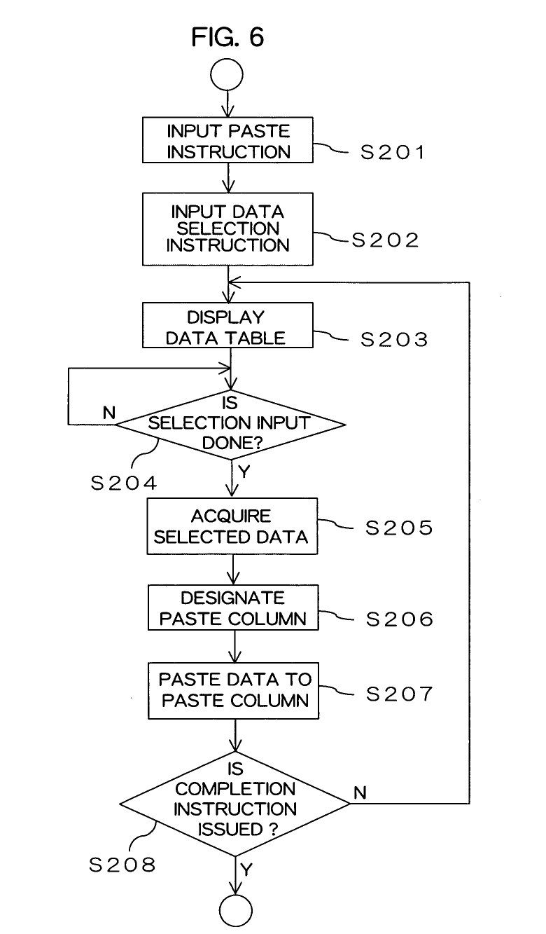

FIG. 6 shows a flow chart explaining another example of the paste operation performed by the mobile terminal according to the embodiment of the present invention. Then, FIG. 6 is a flow chart when a user selects arbitrary data from among the character string data stored in the storage portion 14 to paste the selected arbitrary data. Referring to FIG. 6, when the user, for example, inputs an instruction to paste the character string data to an input column existing in a desired page (S201) and then inputs a data selection instruction aiming at that he/she selects the data to be pasted (S202), the copy control portion 22 instructs the display control portion 20 to display the character string data stored in the storage area of the storage portion shown in FIG. 2 in the form of a table on the display portion 10 (S203).

Next, when the user selects the desired data from among the character string data displayed on the display portion 10 by operating the operation portion 12 (S204), the copy control portion 22 acquires the selected character string data from the storage area of the storage portion 14 shown in FIG. 2 (S205).

Next, when the user designates an input column of a paste destination by operating the operation portion (S206), the copy control portion 22 pastes the acquired character string data to the input column (S207). Thereafter, when a completion instruction is issued from the operation portion 12, the paste operation is completed, while when the operation portion 12 issues no completion instruction, the operation is repeatedly performed from S203 (S208).

Here, the operation portion 12 and the copy control portion 22 operate as second paste means of the present invention.

The page having the input column described above is not especially limited. That is to say, the present invention can be applied to any one of a page represented by the data stored in the storage portion 14 of the mobile terminal, a page within the contents existing on the network, and the like as long as there exists the input column to which the data is to be pasted by using the copy/paste function of the mobile terminal.

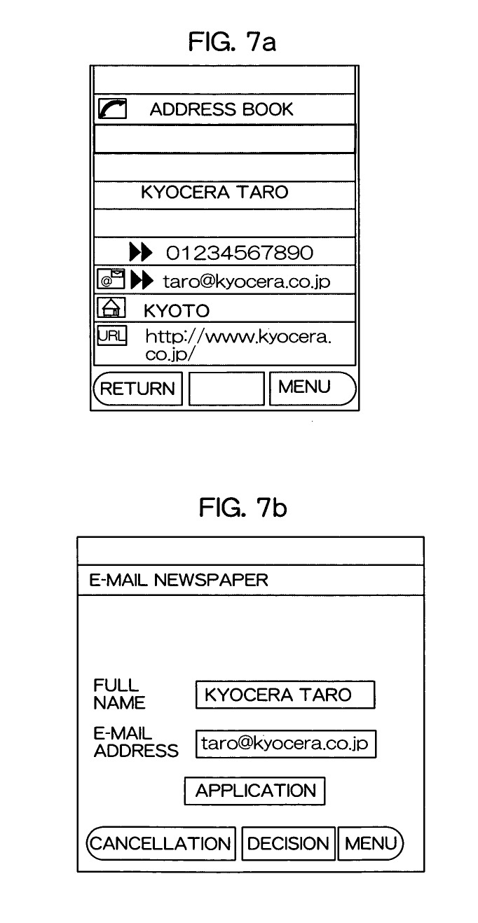

FIGS. 7a and 7b show examples of screens during the paste operation in the mobile terminal according to the embodiment of the present invention. At that, the examples shown in FIGS. 7a and 7b correspond to the flow chart shown in FIG. 5. Referring to FIG. 7a, data in an address book stored in the storage portion 14 is displayed on the display screen of the display portion 10. The address book has the data which is copied through the copy operation shown in FIG. 4 and classified into the character data of the character string types to be stored in the storage portion 14.

When the user specifies the paste destination shown in FIG. 7b and designates the paste, the copy control portion 22 analyzes a source code of the page concerned to recognize that a “full name” column and an “E-mail address” column exist. Next, the copy control portion 22 checks the character string types corresponding to the paste destination, i.e., the character string types of the character string data to be inputted to the “full name” column and the “E-mail address” column. Then, the copy control portion 22 acquires “kyocera taro” as “full name” and “taro@kyocera.co.jp” as “E-mail address” from the data in the address book being displayed on the display portion 10 to paste “kyocera taro” and “taro@kyocera.co.jp”to the “full name” column and the “E-mail address” column, respectively.

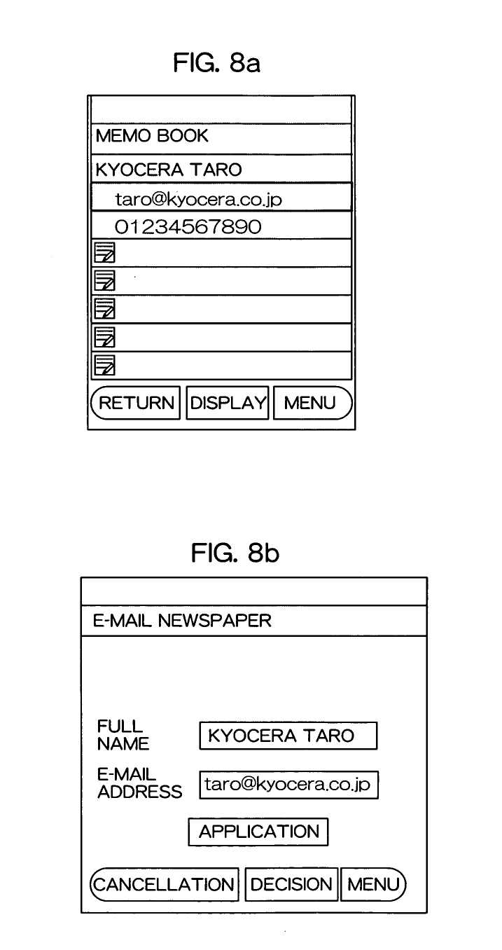

FIGS. 8a and 8b show examples of other screens during the paste operation in the mobile terminal according to the embodiment of the present invention. At that, the examples shown in FIGS. 8a and 8b correspond to the flow chart shown in FIG. 6. Referring to FIG. 8a, data in a memo book stored in the storage portion 14 is displayed on the display screen of the display portion 10. The memo book also has the data which is copied through the copy operation shown in FIG. 4 and classified into the character data of the character string types to be stored in the storage portion 14.

When the user specifies the paste destination shown in FIG. 8b and designates the paste of the selected character string data from the memo book displayed on the display portion 10, the copy control portion 22 acquires the selected character string data from the storage portion 14 to paste the acquired character string data to the input column. In this case, “full name” and “E-mail address” are selected from the memo book screen shown in FIG. 8a and pasted to an application page of an E-mail newspaper shown in FIG. 8b.

What is claimed is:

1. A mobile terminal having a function of copying character data, comprising:
a copy device which copies and fetches therein arbitrary character string data;
a discrimination device which classifies the fetched character string data into the character data of predetermined character string types to punctuate the character string data; and
a character string data storage device which stores therein the classified character string data together with classification item names thereof.

2. A mobile terminal according to claim 1, further comprising first paste device which selects the character string data of the character string type corresponding to a paste destination from among the character string data stored in said character string data storage device to paste the selected character string data.

3. A mobile terminal according to claim 2, wherein said first paste device selects the character string data of the character string type corresponding to a plurality of paste destinations to paste the selected character string data.

4. A mobile terminal according to claim 1, further comprising second paste device which selects the character string data from among the character string data stored in said character string data storage device in accordance with an instruction from a user to paste the selected character string data.

5. A mobile terminal according to claim 2, wherein said second paste device receives an instruction to select a plurality of character string data.

6. A method of controlling a computer, comprising the steps of:
copying and fetching in arbitrary character string data;
classifying the fetched character string data into the character data of predetermined character string types to punctuate the character string data; and
storing the classified character string data together with classification item names thereof.

7. A method of controlling a computer according to claim 6, further comprising the step of selecting the character string data of the character string type corresponding to a paste destination from among the stored character string data to paste the selected character string data.

8. A method of controlling a computer according to claim 6, further comprising the step of selecting the character string data from among the stored character string data in accordance with an instruction from a user to paste the selected character string data.

9. A mobile terminal having a function of copying character data, comprising:
means for copying and fetching in arbitrary character string data;
means for classifying the fetched character string data into the character data of predetermined character string types to punctuate the character string data; and
means for storing the classified character string data together with classification item names thereof.

10. A mobile terminal according to claim 9, further comprising means for selecting the character string data of the character string type corresponding to a paste destination from among the stored character string data.

11. A mobile terminal according to claim 9, further comprising means for selecting the character string data from among the stored character string data in accordance with an instruction from a user to paste the selected character string data.
